(19) United States
(12) Patent Application Publication
(10) Pub. No.: US 2019/0003946 A1
(43) Pub. Date: Jan. 3, 2019

(54) Testing and/or Inspection Device

(71) Applicant: Wolfgang WEINHOLD, Würzburg (DE)

(72) Inventor: Wolfgang WEINHOLD, Würzburg (DE)

(21) Appl. No.: 15/529,049

(22) PCT Filed: Nov. 3, 2015
(86) PCT No.: PCT/DE2015/000528

§ 371 Date: May 23, 2017

(30) Foreign Application Priority Data
Nov. 7, 2014 (DE) 10 2014 016 482.9

(51) Int. Cl. G01N 3/56

(52) U.S. Cl. CPC G01N 3/56

(57) ABSTRACT

A testing and/or inspection device for determining the resistance of objects to abrasion, impacts and/or scratches, including an adaptive retaining device for the object to be inspected, at least one means for placing an active test object proximate to the object to be inspected, and a device for moving the active test object hitting the object to be inspected, as well as a control, inspection and/or display device for controlling and/or inspecting the speed and force at which the active test object contacts the object to be inspected. The device moves the active test object against, on and/or along the object to be inspected, with a carrier device for the active test object, which may be loaded with a weight, and is equipped with a fluid-activated drive, with a non-rotatable thrusting and/or towing device, which is actuated by a control and/or regulating unit and/or can be connected thereto.

### BACKGROUND OF THE INVENTION

### 1. Field of the Invention

The invention is directed to a testing and/or inspection device, useful in particular for testing and/or determining the resistance of surfaces and/or objects to abrasion and/or impact sensitivity and/or scratch resistance.

### 2. Description of the Related Art

Testing devices of this sort are used to examine and evaluate various loads on objects in relation to exposures to another object. In many areas, the object to be inspected is to be examined or evaluated to determine how the latter behaves when some other object comes into contact with it, e.g., when used and/or operated with the fingers or hand, and how many uses and/or contact cycles, e.g., operations, lead to what kind of wear and tear, such as abrasion.

In the automobile industry, for example, tests are to be performed on operating elements, fittings, such as switching handles, upholstery, trim or painted surfaces such as the trunk, hood or door handles, which are touched and/or operated with the hands, fingers or fingernails, but also with other objects, like pockets, clothing or even keys. Known testing devices test such surfaces in varying ways, and are designed as impact, shock, wear or scratch testers.

European Published Patent Application No. EP 2 679 979 A1 discloses a scratch tester for glass panes, which exerts an adjustable force on a cylinder by means of a spring, which in turn presses a diamond secured thereto against the glass pane. The mechanics built up in this way are pulled over the glass pane by means of slide rails arranged thereon on rails secured to the glass pane, and a scratch is generated on the latter. A test and/or inspection value for scratch resistance is obtained based on the force exerted from above on the slide block so as to make the slide rails rest on the glass pane while moving the slide block over the glass surface.

A device for inspecting the scratch resistance of surfaces is also disclosed in Published International Application No. WO 2004/038385 A1. The scratch resistance of a test specimen is here tested using a gas flow mixed with solid particles. The established progression of the gas flow is here equipped with a metering device, by means of which a defined quantity of particles that impact the test object can be introduced into a fixed gas flow.

Another scratching device or testing device for the resistance of a sample is described in German Published Patent Application DE 10 2006 012 374 A1, with which a material sample arranged on a movable table is exposed to a loading body, which is pressed by a weight in the direction of the sample holder. The sample holder is then moved in the (x, y) plane at an adjustable weight with a predefined motion sequence. The arising result for the material sample provides information about the resistance of the material sample to the applied load. Generally known as well is the so-called 3-body wear or the accompanying test, in which two bodies kept in motion with sand interspersed between them are rubbed against each other to obtain information about the wear resistance and/or frictional properties of the object being tested. Varying conditions can be established by selecting a medium other than sand, for example softer or harder materials or solid-liquid mixtures.

Also known under the designation “linear abraser” is a device for determining the wear resistance. A test specimen that has an adjustable height position and can be loaded with weights is here moved over an object to be inspected, so that information can be obtained about the resistance of the test material to being moved back and forth over the test material. Driving here takes place with a conventional electric motor, which uses a gearbox to drive a rod assembly, which subsequently moves up and down, or more accurately to and fro, approximately linearly, and on which the testing means are secured. The electric motor along with the operating, control and display device, including the gearbox and rod assembly, are here inseparably joined together as a unit.

As a rule, known testing and/or inspection devices use either one movable table driven by at least one electric motor, on which the object to be inspected is placed. A test object is then positioned on the object to be inspected with a prescribed force, and the table on which the object to be inspected is positioned is moved. In the other known device, an electric motor uses a gearbox to drive a rod assembly, on which the test object is secured at a fixed height.

In all known variants, the device is designed as a complete unit, and the drive for either the object to be inspected or the test object is realized by an electric motor. Relatively imprecise motion sequences are discernible in particular in the variant where a gearbox drives the thrust rod, which is additionally fixed in terms of height and not guided further outside of the device.

Another disadvantage is that the motions in the known embodiments only take place with a low dynamics and low energy density.

However, these observations are very important in evaluating the resistance of various objects to be inspected, such as partially elastic materials with viscoelastic properties.

### SUMMARY OF THE INVENTION

It is an object of the invention is to provide an improved testing and/or inspection device for examining objects that reduces or avoids the mentioned disadvantages.

In particular, the object of the invention is to be able to test a large number of objects at various locations or especially directly at the place of use and under numerous different conditions. With respect to objects of daily life, this also includes considerations of use and/or operation, for example by hand, which takes place very slowly, and resultantly varying contact with the object to be inspected, such as dry or wet hands, or taking into account various additional components, like cleaning agents, care products or similar substances. However, the goal is to be able to also examine nearly all other conditions and objects that touch very different elements that come into contact with the latter. In particular, very highly dynamic processes, for example vibrations, can be examined and/or inspected with the testing and/or inspection device according to the invention. For example, these also include arising wear, scratches or other damages, e.g., caused by hard objects on surfaces when vibrations arise.

Very important as well is the consideration of outside, for example climatic, conditions, which is very difficult owing to the given rigid architecture of existing testing devices.

According to the invention, a testing and/or inspection device in particular for testing and/or determining the resistance of surfaces and/or objects to wear and/or impact resistance and/or scratch resistance consists of an adaptive retaining device and/or an access device for the object to be inspected and/or a surface to be inspected, at least one means for placing an active test object before or above the object to be inspected, and a device for moving the active test object hitting the object to be inspected, as well as a control, inspection and/or display device for controlling and/or inspecting the speed and force at which the active test object comes into contact with the object to be inspected, wherein the testing and/or inspection device is designed for moving the active test object against and/or on and/or along the object to be inspected, with a carrier device for the active test object, which is and/or can be loaded with an additional weight, and is equipped with a force-activated cylinder, with a thrusting and/or towing device having a non-round design or a non-round cylinder, which is actuated by a least one control and/or regulating unit and/or can be connected with the latter.

In a preferred embodiment of the testing and/or inspection device, the compressed air cylinder, which is designed as a non-round cylinder or equipped with a non-round thrust and/or pull rod, is rotatably or at least inclinably arranged on a retaining device at its closed end or at some other location, either directly or via a mounting fixture. The position at which the compressed air cylinder is secured to the retaining device determines the basic force or weight that prevails at the end of the thrust and/or pull rod given a certain deflection.

The retaining device here preferably allows the vertical adjustment of the accommodated end of the compressed air cylinder, so as to enable a response to different heights of the test objects; alternatively, mounts of varying lengths can be used to adjust the height of the compressed air cylinder to the height of the object to be inspected, or to be able to initially even bring the latter into a horizontal position. To facilitate this setting process, the compressed air cylinder and/or the mounting fixture for the latter has a leveling-display device, like a small spirit level or an integrated and/or attached bubble level.

The end of the thrust and/or pull rod departing from the compressed air cylinder is equipped with a carrier device for the active test object, wherein the carrier device is preferably rotatable in design, for example so that various angles of contact can be set for the active test object relative to the object to be inspected.

In one embodiment, the active test object is arranged at the end of a rod or bar, which is guided through the carrier device on the thrust and/or pull rod and can be fixed thereon, e.g., by means of a locking screw. Additional weights can be arranged on the carrier device or along the rod or bar to whose one end the active test object is secured, so as to set the force with which the active test object hits the object to be inspected.

The testing and/or inspection device designed in this way makes it possible to load the object to be inspected with the definable weight of the rocking part, the compressed air cylinder situated in the mount, the carrier device with the active test object as well as the additionally set weight with additional weights. The selected design of a non-round compressed air cylinder and/or a non-round thrust and/or pull rod gives the active test object, once its position has been set, a very non-rotatable design in relation to the object to be inspected, and the thrust and/or pull rod need not additionally be guided. The device configured in this way also allows the active test object to follow the contour and/or irregularities of the object to be inspected, since the end of the compressed air cylinder is rotatably mounted.

As a consequence, even nonplanar objects and/or surfaces can be very effectively tested, inspected or examined.

The compressed air cylinder is connected or connectable with a control and/or regulating unit, as well as with a compressed air supply, and permits very high dynamics along with high forces relative to the motion and speed with which the thrust and/or pull rod moves the active test object over the object to be inspected. The controller can also be used to set different speeds variable within a broad range for each motion, making it possible to better and more precisely test and evaluate an object with a preferred direction and/or objects for specific directions of motion, for example. In another preferred embodiment of the invention, the force and/or compressed air cylinder is also equipped or connected with a pressure gauge, with which the control and/or inspection device is connected, and/or with a position and/or path measuring system, so that the introduced force and/or the path can be measured, and is made available very easily in a force-path diagram, for example. In another embodiment, the testing and/or inspection device is also equipped with a force measuring device, for example a load cell underneath the object to be inspected, making it possible to examine and/or evaluate stick-slip effects like adhesive and/or slipping effects of solid bodies moved against each other, e.g., creaking doors or clattering windshield wipers. The testing and/or inspection device according to the invention and the adjustable parameters for test object motion, control and/or inspection and measurement, as well as the addition of a wide variety of test fluids make it possible to test and/or acquire nearly all tribological surface properties of a test object. In addition, the testing and/or inspection device according to the invention can be used to initiate a variety of friction measurements, and to test, inspect and evaluate lubricants and/or oils, for example, so as to ascertain friction coefficients, for example.

In a preferred embodiment of the testing and/or inspection device according to the invention, the latter is designed on a base plate with a retaining device for the object to be inspected as well as a retaining device for the rotatably and/or inclinably secured compressed air cylinder. Additional retaining and/or driving elements for the compressed air cylinder can be provided on the base plate, for example so as to be able to fixedly secure it in an inclination to be established or to lift the latter at one location and lower it again.

In one embodiment of the testing and/or inspection device, the retaining device for the object to be inspected can be swiveled, in particular swiveled or tilted by about 90°, so that the active test object can optionally be moved on and/or along the object to be inspected vertically (parallel to gravity) or horizontally (perpendicularly to gravity). In another preferred embodiment of the testing and/or inspection device, a web-like material is arranged in front of the object to be inspected and between the latter and the active test object acting on it. This web-like material is preferably a fabric and/or textile, which is additionally exposed to a test liquid during the inspection. A wide variety of parameters can be achieved or replicated for the inspection by correspondingly selecting the material of the web-like medium, as well as selecting the test liquid. For example, a corresponding roughness makes it possible to simulate the surface of hands or special gloves, and to test and/or check and/or determine how often the object to be inspected can be placed under what kind of load by the active test object under these conditions. For example, by adding the corresponding liquids and/or lotions and/or other additives, it can be tested and/or checked and/or determined how the objects to be inspected will behave during simultaneous contact with washing agents, cleansers, other chemicals or materials, for example.

The numerous options for setting, adjusting and adapting the testing and/or inspection device in this way make it possible to simulate very lifelike situations and/or situations of daily life under all conceivable outside conditions, and to acquire very informative and reliable knowledge. For example, the testing and/or inspection device according to the invention can be used by a person to simulate operating processes on a switch, keyboard or another operating element using a hand or finger. For example, selecting the hardness of the active test object and the web-like, prestressed material and/or the additionally used test liquid also makes it possible to test contact with the fingers, hand or other surfaces or bodies after the addition of a cleaning liquid or some other fluid, a cream or a chemical.

In another variant, the testing and/or inspection device is partially arranged in a climatic chamber in order to determine results or measured values about the achievable load and/or load limits and/or run verifications under extreme outside conditions. The control, inspection and display device is here preferably separated from the remaining components of the testing and/or inspection device, located outside of the climatic chamber so as to protect electrical and/or electronic components and/or maintain their function. The compressed air cylinder in this variant is equipped as needed with a locally acting insulation and/or a heater, such as an applied heating foil, which is actuated via the control and/or inspection device situated outside of the climatic chamber. In this way, for example, tests and/or inspections can be conducted at temperatures of up to minus about 40° C. or below. In order to take into account the temperature at which the test and/or inspection takes place, the testing and/or inspection device has a temperature sensor in proximity to the object to be inspected, which transmits the values to the control, inspection and/or display device. The compressed air feeders for the compressed air cylinder, which are routed in from the compressed air supply and/or the control and inspection device outside of the climatic chamber, are preferably insulated or provided with a trace heater.

The head of the active test object has a variable shape, size and hardness, and is preferably replaceable in design. Various mounts can preferably be attached, thus also allowing very special objects to be used as active test objects, e.g., a key, which comes into contact with the paint on the door handle or a textile surface or some other surface. For example, a head with a Shore hardness ranging from about 40 to about 50 has proven to be a preferred variant for applications in a climatic chamber at roughly minus 40° C. For other applications, the head is covered with a textile and/or absorbent material, or consists of the latter.

While it will be appreciated that the inventive device may be used to test objects and surfaces, for ease of reference, it is intended that the term “object” as used herein would include a “surface”, unless the context indicates otherwise.

Also for ease of reference, the term “adaptive retaining device” may include an “access device”.

It will be likewise understood that the term “control device” may include a device not only for controlling, but also, or alternatively, for inspection and/or display.

One of ordinary skill in the art will appreciate that when reference is made to “contact” with an object to be inspected includes the term “contact” would embrace impacting, and/or moving along the surface of the object.

For further ease of reference, when using the term “thrusting”, it is intended to include “towing”.

Other objects and features of the present invention will become apparent from the following detailed description of the presently preferred embodiments, considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a perspective view of one embodiment of the inventive testing and/or inspection device;

FIG. 2 is perspective view of a second embodiment of the inventive testing and/or inspection device from FIG. 1 with a retaining device set up;

FIG. 3 is a schematic view of another variant of a testing and/or inspection device with a fluid application device; and

FIG. 4 is a perspective view of a further embodiment of the inventive testing and/or inspection device with the moving device swiveled out.

### DETAILED DESCRIPTION OF THE PRESENTLY PREFERRED EMBODIMENTS

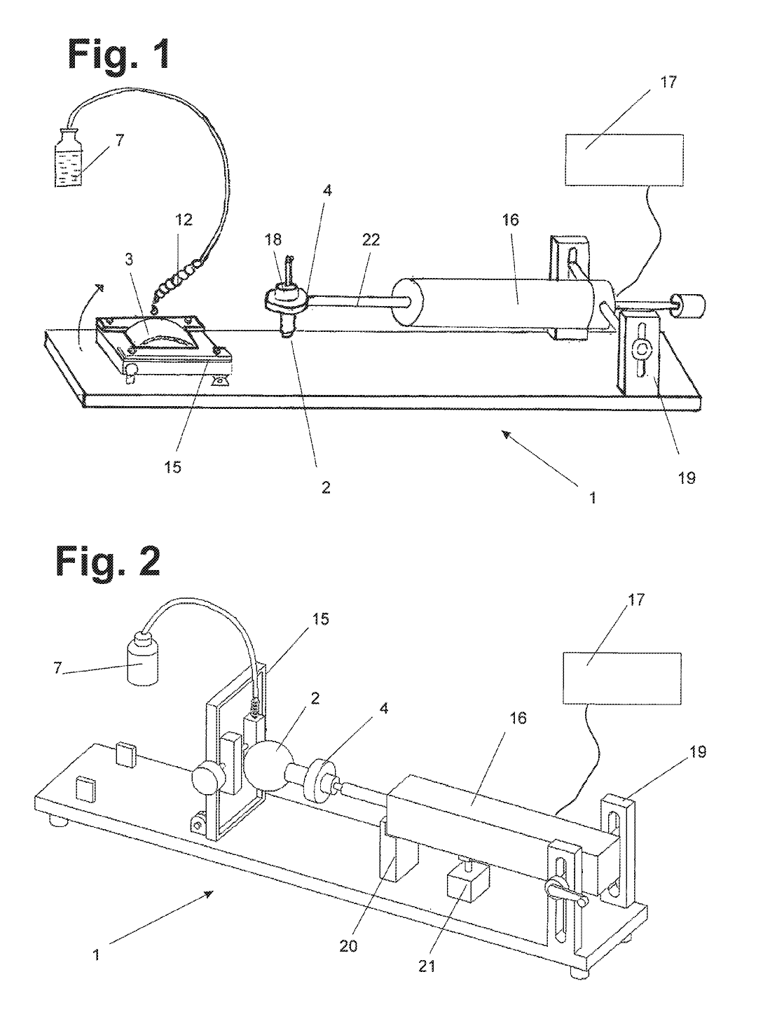

FIG. 1 shows a testing and/or inspection device according to the invention, in which an object to be inspected 3 or a partial piece of an object can be secured in a retaining device 15 at a definable height and spaced apart from a moving device 16. Moving device 16 is designed as a force and/or compressed air cylinder 16, which preferably has a thrust and/or pull rod 22 with a non-round design or a non-round cylinder 16 (not shown in detail in this view), and its end is preferably rotatably or at least inclinably secured in a fastening device. This fastening design can involve clamp screws or bolts, fixed against rotation as needed. Because the force and/or compressed air cylinder 16 is designed as a non-round cylinder and/or the pull and thrust rod 22 is designed as a non-round element, this arrangement yields an intrinsically non-rotatably designed moving device for the active test object 2 at the end of thrust rod 22. In this embodiment, thrust rod 22 need not be additionally mechanically guided at a great outlay to enable a uniform movement of the active test object 2 with a carrier device 4.

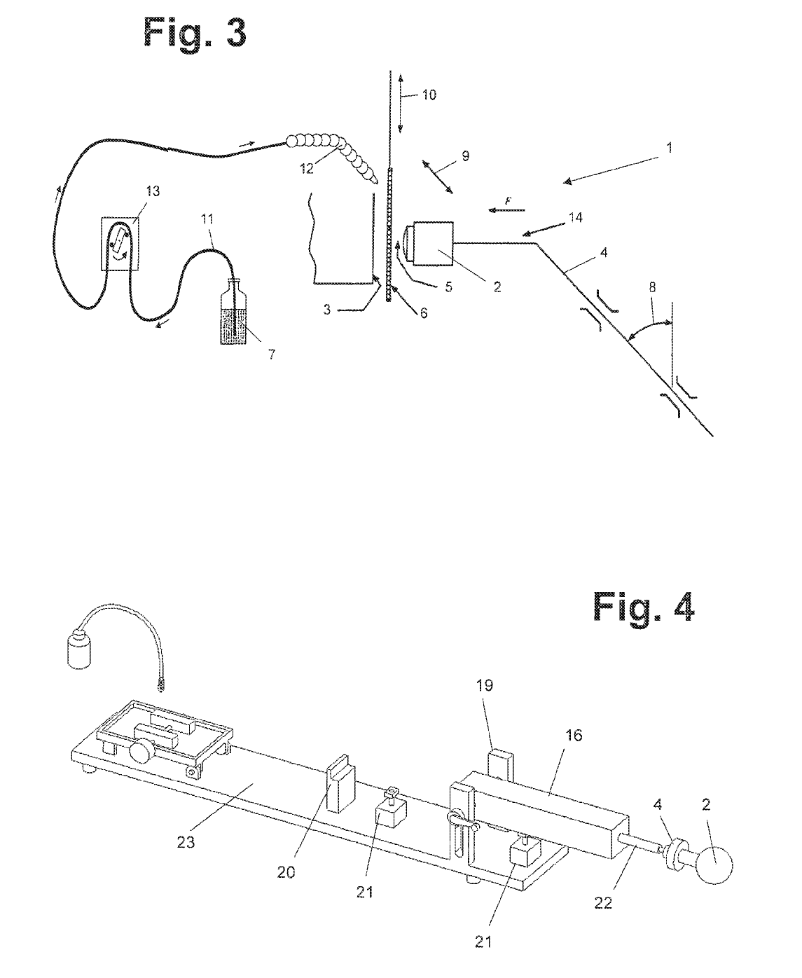

In addition, the embodiment of the testing and/or inspection device that includes cylinder 16, the rear end of which is inclinably secured to a retaining elements 19, enables the inspection of nonplanar test objects 3. Due to the rotatable mounting of cylinder 16 on retaining elements 19, active test object 2 secured to the front end of thrust rod 22 can follow a contour, e.g., a curvature, when resting on the object to be inspected 3 as thrust rod 22 moves back and forth. This would not be possible with a fixed cylinder. However, fixing cylinder 16 in place can indeed make sense for an alternative application, for which purpose a fixing or limiting means 20 is provided in an alternative embodiment (see, e.g., FIG. 2 and FIG. 3).

In this variant shown in FIG. 1, retaining device 15 for the object to be inspected is arranged together with compressed air cylinder 16 on a shared base plate, which creates a compact inspection unit, with which recurring testing and/or inspection sequences are to be comfortably executed. Moving device 16 with its end-side fastenings 19 and possibly with a support 20 for cylinder 16 can basically be set up at any site desired or at a prescribed location for the test and/or inspection setup. For example, this may be necessary if a test object is fixedly installed at a location, and the test and/or inspection sequence must also take place directly at this location. Diverse variants for the fastening elements 19 at the end of the cylinder can be used for this purpose, for example massive suction bases, magnetic plates or adhesive or mechanical connecting devices, depending upon the needs of the application.

In an embodiment, an opening in the base plate is also provided at the site of the retaining device 15, making it possible to position the base plate itself over the object to be inspected. The test specimen is then aligned in such a way that it can pass through the opening and come into contact with the object to be inspected (including a surface to be inspected). This yields a mobile loading unit on the base plate with an opening for establishing contact between the active test object and the object to be inspected.

In the depicted testing and/or inspection setup with the device according to the invention as shown in FIG. 1, an object 3 that is secured to a retaining device 15 in a line or, more succinctly, parallel to the compressed air cylinder 16 on the shared base plate, is passed over by an active test object, or the active test object 2 is pushed and/or pulled over the object to be inspected by means of the compressed air cylinder 16.

The height of the active test object 2 is here adjustable on carrier device 4 at the end of the thrusting and/or towing device, which leads into the cylinder 16, so that the intensity with which the active test object 2 touches the object to be inspected 3 can be varied. Furthermore, additional weights 18 can be placed on retaining device 4 for the active test object, so that different forces can be set for the active test object acting on the object to be inspected.

The control, regulating and inspection device 17 is preferably separate from compressed air cylinder 16 of the retaining device for objects to be inspected and the shared base plate, but, in order to create a very compact inspection and/or testing device, can also be installed on the shared baseplate together with the mentioned components, and be completely connected in terms of compressed air and electricity. The inspection unit here preferably has interfaces for transmitting the data to other IT devices and/or output devices, such as printers or the like. Transmission is optionally wired and/or wireless, for which corresponding interfaces are provided, such as LAN, WLAN, Bluetooth, or those for other radio transmission methods.

In particular, the separate variant offers the option of realizing inspection and/or testing sequences under very unfavorable temperature conditions, e.g., in a low-temperature chamber at temperatures of below minus about 30° C. The cold-sensitive electronics and in particular the display unit can here be positioned outside of the low-temperature chamber. In such an embodiment, the compressed air feeders operated with absolutely dehumidified air as well as the compressed air cylinder preferably are equipped with a very placed and controllable local heater and/or insulation, for example with heating foils and/or tubular heaters being used for the compressed air cylinder and feed lines. For this type of application, the testing and/or inspection device preferably has at least one temperature sensor connected with the inspection and/or control device on or near the object to be inspected, so as to record and/or determine the temperature at which the inspection and/or test is performed on the object.

For example, the embodiment of the testing and/or inspection device shown in FIG. 1 can be used to simulate scratching, rubbing, scraping or similar contacting processes of an object, and ascertain the resistance of the object to be inspected in this way. The selectable active test objects can also be used to thereby reenact and inspect realistic situations, e.g., touching an object with the fingers or fingernails and how this affects the objects to be inspected. In this way, various conditions can be realistically chosen by selecting suitable heads of the active test object, and the objects to be inspected can be checked very precisely for their load-bearing capacity under the conditions set.

As a result, tests and/or inspections regarding the resistance of objects to be inspected are very readily possible for very different conditions, e.g., roughness of the objects hitting the object to be inspected or effects at various ambient temperatures.

In various inspections, in particular of viscoelastic objects, the embodiment according to the invention with a compressed air cylinder as a drive for the active test object is suitable for exposing the object to be inspected to very high speeds, and hence energy densities. The viscoelasticity of the object here plays a large role, since the latter experiences little impairment during exposure to relatively large forces but low speeds, while becoming damaged very quickly at elevated speeds of movement. This has to do with the peculiarity that the restoration of the object after exposure to a load takes place slowly, and the latter suffers damages very quickly at high speeds of movement of the active test object on the object to be inspected, since the arising forces build up.

As a consequence, the device according to the invention enables a very precise measurement of a frequency that will do damage to the object to be inspected. For example, running a fingernail along a leather surface will cause no appreciable damage, even at a higher pressure but given a slow movement. However, this changes very quickly due to the viscoelasticity of the object, e.g., upholstery or the leather itself, if the speed of movement at which this action takes place is increased. The leather surface is here damaged or destroyed after a relatively short time. The values ascertained in such an inspection and/or testing device according to the invention quickly provide information given questions relating to the usability of various materials and/or information about damages that occurred.

In another embodiment, the inspection and/or testing device is equipped with an application device 12 by means of which a fluid 7 can be supplied as the active test object 2 contacts, brushes or corrodes the object to be inspected 3 so as to simulate various external influences. For example, all conceivable contacts between the object and test object can be additionally checked using a test liquid, e.g., sweat, cleaning agents, drugs or other chemical products, and the resistance of the objects to be inspected can be tested and/or measured and/or checked taking these circumstances into account.

In another variant according to FIG. 2, the active test object 2 that hits an object to be inspected takes the form of an extension of thrust and/or pull rod 22 of cylinder 16. By activating compressed air cylinder 16, the active test object prescribed according to the inspection and/or test criteria that is secured to thrust rod 22 by means of a mount 4 is moved against the object to be inspected 3 and brought into contact with the latter. The inspection and/or control device can here be used to prescribe precisely how often and at what time and with what force the active test object is to be moved and/or impacted against the object to be inspected. This could involve simulating a scanning and/or switching process, in which the resistance of an operating element and/or its labeling and/or its imprint can be ascertained in relation to operating processes.

To make the process of contacting an object 3 as realistic as possible, the inspection and/or testing device in another preferred embodiment variant shown in FIG. 2 or FIG. 4 is equipped with at least one lifting device 21 for the cylinder 16 rotatably mounted to the attachment points 19. As a result, before the active test object 2 hits the object to be inspected 3, the cylinder 19 is slightly lifted in the front region, and then lowered again before the active test object 2 impacts the object 3 to be inspected, thus resulting in a very realistic, true to life brushing movement when pressing on the object to be inspected.

FIG. 3 also shows an inspection and/or testing device that generates a pressing movement along the object to be inspected 3, wherein in this schematically depicted embodiment, the cylinder is not lifted by means of a controllable lifting device. A mechanical embodiment is used to generate the mentioned, downwardly directed brushing pressing movement, and the movement is achieved by means of an angled 8 connecting rod 4 and a spur to which the active test object 2 is secured.

The mentioned variants of the inspection and/or testing device according to the invention are or can be equipped with an application device as needed, by means of which a fluid 7 can be supplied as the active test object 2 contacts, brushes or corrodes the object to be inspected 3 so as to simulate various external influences. FIG. 3 shows an application device automated for this purpose that operates continuously during the inspection and/or testing process. As shown by example according to FIG. 3 for the inspection and/or testing device, a web-like material 6 is here arranged between the object to be inspected 3 and the active test object 2, which is automated to dispense a metered fluid 7 via a conveying device 13 to the web-like material 6 by means of a positionable delivery system 12.

In another embodiment of the inspection and/or testing device shown in FIG. 4, cylinder 16 can be completely swiveled, so that objects to be inspected can also be tested outside of a shared base plate 23. As shown here, in order to potentially simulate the movement that takes place slightly from above, the right side of attachment device 19 is provided with another lifting device 21 for cylinder 16, which is actuated by the control and/or inspection unit. This makes it possible to very easily also inspect and/or test objects that cannot be introduced into the retaining device of the inspection and/or testing device.

Having described preferred embodiments of the invention with reference to the attached drawings, let it be noted that the invention is not limited to these precise explanations, and that various changes and modifications can be made thereto by an expert without deviating from the scope of the invention as defined in the attached claims.

In the preceding Detailed Description, reference was made to the accompanying drawings, which form a part of this disclosure, and in which are shown illustrative specific embodiments of the invention. In this regard, directional terminology, such as “top”, “bottom”, “left”, “right”, “front”, “back”, etc., is used with reference to the orientation of the Figure(s) with which such terms are used. Because components of embodiments can be positioned in a number of different orientations, the directional terminology is used for purposes of ease of understanding and illustration only and is not to be considered limiting.

Additionally, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A testing and/or inspection device for testing and/or determining the resistance of an object to be inspected to abrasion, impact sensitivity and/or scratch resistance, the device comprising:
an adaptive retaining device for retaining the object to be inspected;
at least one means for placing an active test object contained in a carrier in proximity to the object to be inspected;
a device for moving the active test object into contact with the object to be inspected;
a first control device for performing at least one of the functions of controlling and inspecting at least one of the speed and force at which the active test object comes into contact with the object to be inspected;
wherein the carrier device is configured to receive an additional weight, and is equipped with a fluid-activated drive, the fluid-activated drive having a non-rotatably mounted thrusting device, which is actuated by a least one second control device.

2. The device of claim 1, wherein the fluid-activated device is a force cylinder.

3. The device of claim 1, wherein at least one of the fluid-activated drive and the thrusting device is non-round in shape.

4. The device of claim 1, wherein the movement of the active test object with respect to the object to be inspected is oriented vertically with respect to gravity.

5. The device of claim 1, wherein the movement of the active test object with respect to the object to be inspected is oriented horizontally with respect to gravity.

6. The device of claim 1, wherein at least one of the retaining device and the device for moving the active test object is rotatable.

7. The device of claim 1, wherein the active test object is a test stamp, and a web-like material is arranged between the test stamp and the object to be inspected.

8. The device of claim 7, wherein the web-like material has a characteristic of at least one of being formed at least partially of a textile material, and having a defined level of roughness.

9. The device of claim 1, wherein the fluid-activated device includes at least one heater.

10. The device of claim 1, wherein the device for moving and the first control device include spatially separable units.

11. The device of claim 8, wherein at least the following elements are sized to be accommodated in a standard climatic chamber: the adaptive retaining device, a means for securing the textile material, the textile material itself and a device for moving the test stamp.

12. The device of claim 1, wherein the active test object includes a replaceable, at least partially elastic, head.

13. The device of claim 1, wherein a head of the active test object has a Shore hardness in the range of from about 40 to about 50 at a temperature of −40° C.

14. The device of claim 1, wherein the fluid-activated drive is connected with at least one of a housing and a retaining device by an insulating device.

15. The device of claim 1, wherein connections between the moving device for the active test object and the first control device are one of insulated and partially heated.

16. The device of claim 1, wherein at least one of the active test object and a head of the active test object is at least partially covered by an at least partially textile material.

17. The device of claim 1, wherein a head of the active test object is at least partially covered by an at least partially absorbent material.

18. The device of claim 1, wherein the fluid-activated drive is at least one of non-rotatable and fixable in a defined position.

19. The device of claim 1, wherein the fluid-activated drive is equipped with at least one temperature sensor secured directly thereto, which temperature sensor is configured to be connected with at least one of the first and second a control devices.

20. The device of claim 1, further comprising at least one temperature sensor positioned in the area of the object to be inspected.

21. The device of claim 1, further comprising a feeding device for exposing at least one of the active test object and the test body to a prescribed quantity of a defined fluid during the inspection.

22. The device of claim 1, wherein the device is a scratch tester.

23. The device of claim 1, wherein the device is an abrasion tester.

24. The device of claim 1, wherein the device is one of a rubbing, scraping, turning or rolling tester.
